(19) United States
(12) Patent Application Publication
(10) Pub. No.: US 2008/0061460 A1
(43) Pub. Date: Mar. 13, 2008

(54) Method and device for the production of blown tubular film

(76) Inventors: Richard Zimmermann, Bonn (DE); Gerd Fahling, Eitorf (DE)

Correspondence Address: Wyatt, Gerber & O' Rourke, LLP, 99 Park Avenue, New York, NY, 10016, US

(21) Appl. No.: 11/518,465

(22) Filed: Sep. 8, 2006

(51) Int. Cl. B29C 47/92; B29C 55/28

(52) U.S. Cl. 264/40.1; 264/40.6; 264/564; 425/141; 425/526

(57) ABSTRACT

A process of controlling the thickness profile of a blown tubular film, consisting of thermoplastic plastics, around the circumference of same when producing blown film by means of blown film extruders, having a film extrusion die, wherein a measuring device measures the film thickness of the tubular film around the circumference and wherein a control device variably controls the cooling gas flow as a function of the measured film thicknesses around the circumference in sectors, wherein cooling gas flows are supplied from the outside in the direction of production in two separate planes, and wherein the cooling gas flows are controlled variably and in circumferential sectors around the circumference in the two planes in respect of their physical parameters.

### FIELD OF THE INVENTION

The invention relates to a process of controlling the thickness profile during the production of blown tubular film, and devices for carrying out such a process. Tubular film leaving the annular nozzle of a blown film extruder has a thickness profile around the circumference of the tubular film. The thickness profile may comprise circumferentially distributed, thicker and thinner regions which are largely fixed in position. Such an uneven distribution of thickness around the circumference can have an adverse effect during the coiling and further processing of the tubular film.

It is advantageous to reduce the deviations of the circumferential thickness profile at the early stage of producing the tubular film. When the tubular film is blown, i.e. when expanding the tube diameter, hotter regions are expanded to a greater extent and cooler regions to a lesser extent. Generally, the differences in the thickness of the tubular film around the circumference are influenced by varying the cooling output or by varying the heating of the film extrusion die.

If the cooling output in one circumferential sector is higher, the tubular film cools down more quickly and thus expands to a lesser extent and retains a relatively greater film thickness. If the cooling output in one circumferential sector is lower, the tubular film retains a higher temperature and is therefore more expandable. Thus, the film thickness is reduced to a greater extent.

The differences in film thickness around the circumference are determined by a measuring device and transmitted to a control device for varying the cooling or heating output. Generally, the measuring device is arranged in the direction of production behind a freezing zone of the film material, where the film material is no longer plastically expanded.

### BACKGROUND OF THE INVENTION

In recent years, the increased output of modern blown film extrusion systems has led to more stringent requirements regarding the efficiency of thickness profile control systems. An output increases, temperature inhomogeneities in the extrusion part as well as instabilities of the film hose in the region of the direct cooling gas supply also increase. These increases, in turn, lead to greater inhomogeneities in the thickness profile of the film tube around the circumference.

In DE 100 29 175 A1, a device is described for controlling the thickness profile during the production of blown film to be used at the extrusion die of a blown film extruder. The device comprises a main cooling ring as well as a supplementary cooling ring, arranged underneath the main cooling ring. The cooling rings control the variable temperature of gas flows in several sectors. The supplementary cooling ring is positioned directly above the exit nozzle of the extrusion die. The main cross-sectional expansion of the blown film tube takes place above the main cooling ring.

The manufacturer Windmöller & Hölscher K G offers a type of cooling ring system for the production of blown film, wherein, above the extrusion die nozzle, two cooling rings are arranged at an axial distance from one another. The first cooling ring is arranged directly on the extrusion die and is provided with a plurality of heating elements, which elements are individually controlled. Similar to a long-neck mode of operation, the main increase in the cross-section of the blown film tube takes place above the second upper cooling ring which ejects a circumferentially uniform uncontrolled cooling gas flow. The length of the tube forming zone, from the nozzle exit to the freezing limit at a calibration basket, is increased. However, the material extension is only slight in the bottle-neck-shaped region between the first cooling ring and the second cooling ring.

### OBJECT OF THE INVENTION

It is an object of the present invention to provide a process and device for the production of blown tubular film to provide improved results regarding the distribution of the circumferential thickness variation of the tubular film. One objective is achieved by providing a process and device for of controlling the thickness profile of a blown tubular film.

### SUMMARY OF THE INVENTION

A process and device is provided for controlling the thickness profile when producing blown tubular film by blown film extruders. The process and device can include the use of a film extrusion die, wherein a measuring device measures the film thickness of the tubular film around the circumference. A control device is further provided which variably controls the cooling gas flow as a function of the measured film thickness around the circumference in sectors. Cooling gas flows are supplied from the outside in the direction of production in two planes arranged at a distance from one another. The cooling gas flows are controlled variably and in sectors around the circumference in the two planes in respect of their physical parameters. Accordingly, a method and device for controlling the thickness profile of a blown tubular film consisting of thermoplastic plastics during the production of tubular film, to be arranged at a blown film extruder with a film extrusion die is provided.

A method and device according to the invention comprise a measuring device for measuring the thickness profile of the tubular film, which measuring device measures the film thickness of the tubular film above a freezing limit around the circumference. A control device is provided which controls the cooling gas flows variably around the circumference as a function of the measured film thickness. Two cooling rings are provided which can be arranged above the film extrusion die of the blown film extruder in two planes arranged at a distance from one another. The two cooling rings comprise means with the help of which the cooling gas flows can be variably controlled in sectors around the circumference.

A process and device according to the invention provides that cooling gas flows are controllable in sectors in a circumferentially and variable manner. The cooling gas flows can be supplied along a considerable length of the production process from the exit of the tubular film from the nozzle extrusion die as far as close to the entry of the tubular film into a calibration basket without the effect of the cooling gas flows being lost through mixing or heating after a short distance in the direction of production. The ejection speed of the tubular film can be considerably increased due to the fact that the operating range of the circumferentially variably controllable cooling gas supply is been greatly extended. Thus, while quality is maintained, an increase in the production rate is been achieved.

It is preferable that the variable change of the cooling gas flows occur in those regions where, as a result of the final pronounced cross-sectional extension of the film tube, a transverse extension of the material occurs such that individually differing cooling rates around the circumference can lead to a correction in the thickness distribution. This is also the case with a simple cooling ring with a supplementary cooling ring, however the effective axial cooling range is short such that cooling can be insufficient at high output rates. On the other hand, a double cooling ring may not be sufficient since, before the substantial increase in the cross-section of the film tube at the second cooling ring occurs, substantial uniform cooling around the circumference may occur whereby any existing errors in the thickness profile are formed and remain.

Changes in the physical parameters of the cooling gas flows include variations in volume flows as well as changes in the temperature of the cooling gas. An independent control of two planes is possible in an embodiment of the invention, whereby it is possible to apply different control procedures, such as by exerting the influence in a first plane in accordance with a rough procedure and in a second plane according to a fine procedure. It is also possible to control the thickness profile so as to achieve a constant thickness of the tubular film and to set different thickness distribution structures and to maintain those in a controlled manner. The circumferential cooling air distribution can be uniformly controlled at both cooling rings and at both exit planes respectively, or the cooling can be provided according to corresponding control procedures. Cooling can also be provided at angularly offset cooling ring planes or in the two cooling planes, and in manners which are adjusted with respect to one another. The thickness profile is preferably measured in one plane only behind the second cooling ring.

A through aperture of the cooling rings can be provided and adapted to the diameter development of the film tube. In one embodiment, the lower entry diameter for the film tube at the cooling rings is smaller than the upper exit diameter for the film tube. Furthermore, in another embodiment, an inner cone can be provided which contains two axially spaced diameters and comprises a smaller opening angle at the lower cooling ring than at the upper cooling ring, which is determined by the entry diameter and exit diameter of the cooling ring and by the axial distance therebetween. The internal geometry of the cooling rings can be accompanied by a graduation of several annular nozzles or nozzle lips of each cooling ring within the respective inner cone whose differences in diameter can be less pronounced at the lower cooling ring than at the upper cooling ring.

In a production phase, the diameter of the two cooling gas supply means or cooling rings can be adapted to a change in the diameter of the tubular film in such a way that the lower cooling ring comprises a smaller inner diameter than the upper cooling ring. The ratio of the entry diameter of the upper cooling ring to the lower cooling ring can be greater than 1.1, and in one embodiment greater than 1.2. Each of the two cooling rings can comprise two partial flows of which a first smaller partial flow is circumferentially controllable in sectors, with a second greater partial flow being circumferentially uniform. The latter greater partial flow can exit in two annular nozzles arranged one above the other, such as behind the first partial flow.

In an additional embodiment, in addition to the cooling air controllable in sectors, it is possible to control the temperature setting for the film material in the extrusion die, either by heating or cooling. The control of the cooling air flow of both cooling rings and optionally the control of the temperature setting can be combined in one control circuit.

In a further embodiment, the control of the thickness profile by the outer cooling rings can be accompanied by a circumferentially variable control of the tubular film from the inside, and an inner cooling gas flow can be provided for circumferentially control in sectors. It is possible to provide joint control measures on the inside and on the outside. The sectorial inner cooling can take place in two planes in the direction of production, which two planes are preferably associated with the planes of the outer cooling rings.

By being able to control the axial distance between the cooling gas flows and cooling rings respectively, it is possible to ensure adaptation to different production speeds. This also facilitates the production start in that it becomes possible to provide access to the film nozzle of the extrusion die.

### BRIEF DESCRIPTION OF THE DRAWINGS

Preferred embodiments of the inventive devices are illustrated in the drawings and will be described below.

FIG. 1 illustrates a film blowing system according to the invention with two cooling rings which each comprise a controllable partial cooling ring with control elements for independently influencing the cooling gas flows in sectors, and an uncontrolled partial cooling ring.

FIG. 2 illustrates a film blowing system according to FIG. 1 with additional temperature setting means of the film extrusion die, which are controllable in sectors.

FIG. 3 illustrates a film blowing system with two cooling rings which each comprise a uniformly shaped cooling ring with control elements for independently influencing the cooling gas flows in sectors.

FIG. 4 illustrates a film blowing system according to FIG. 3 with additional temperature setting means of the film extrusion die, which are controllable in sectors.

FIG. 5 illustrates a film blowing system with two cooling rings which each comprise a standard cooling ring with control elements for independently setting the temperature of the cooling gas flows in sectors.

FIG. 6 illustrates a film blowing system according to FIG. 5 with additional temperature setting means of the film extrusion die, which are controllable in sectors.

FIG. 7 illustrates a film blowing system with two cooling rings of which the first one comprises a controllable partial cooling ring with control elements for independently influencing the cooling gas flows in sectors and an uncontrolled partial cooling ring, and of which the second one comprises a uniformly shaped cooling ring with control elements for independently influencing the cooling gas flows in sectors.

FIG. 8 illustrates a film blowing system with two cooling rings which each comprise a controllable partial cooling ring with control elements for independently influencing the cooling gas flows in sectors, and an uncontrolled partial cooling ring for independently influencing the cooling gas flows in sectors

FIG. 9 illustrates a film extrusion die, the lower controllable partial cooling ring with corresponding cooling gas supply means according to FIGS. 1, 2 and 7 in an enlarged partial section.

FIG. 10 illustrates nozzle exits at the lower controllable cooling ring according to FIG. 9 as an enlarged detail.

FIG. 11 illustrates a disc element of the lower controllable cooling ring according to FIG. 9 in a plan view.

FIG. 12 illustrates an extrusion die with the lower controllable partial cooling ring, the lower uncontrolled partial cooling ring and the inner cooling ring according to FIG. 8 in an enlarged partial section.

FIG. 13 illustrates exit nozzles of the lower controllable cooling ring and the inner cooling ring according to FIG. 12 as enlarged details.

FIG. 14 illustrates a disc element of the inner cooling ring according to FIG. 12 in a plan view.

### DETAILED DESCRIPTION

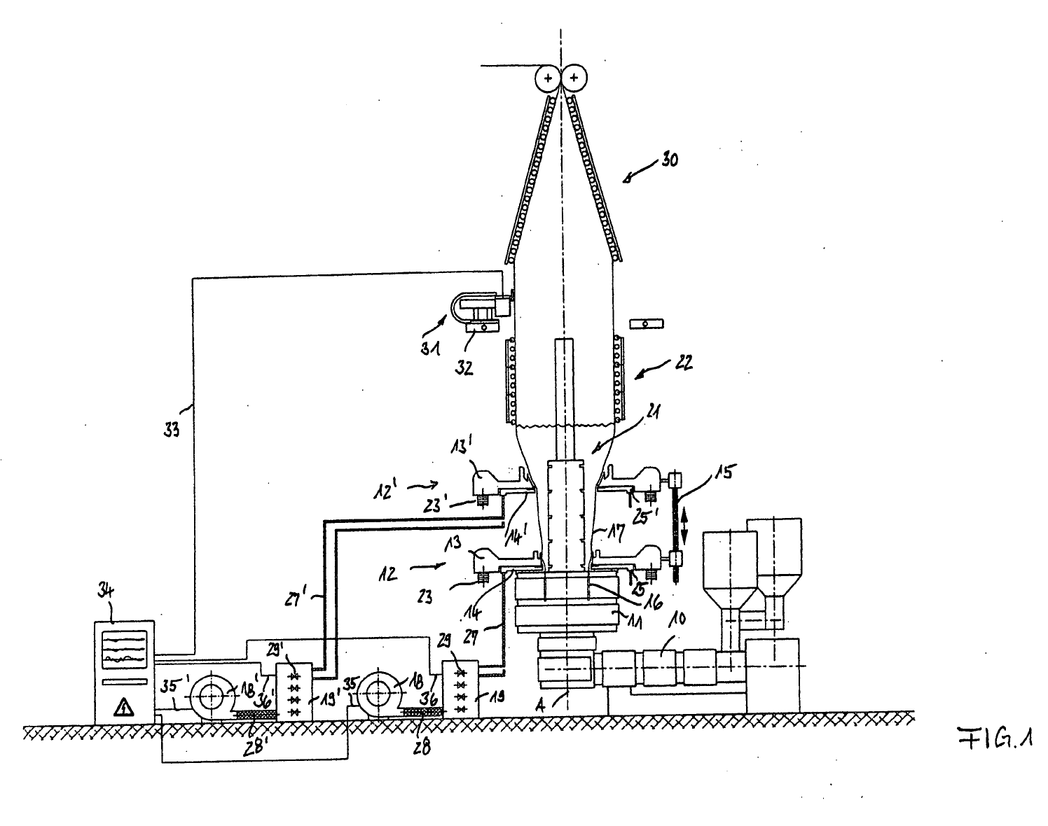

A device according to the invention shown in FIG. 1 comprises a film blowing extruder 10 with an extrusion die 11, a first cooling ring 12 with an annular channel 13 for a constantly uniformly emerging partial cooling gas flow and a segment disc 14 arranged underneath the latter, for a partial cooling gas flow controllable in sectors, as well as a second cooling ring 12′ arranged thereabove. A annular channel 13′ is provided for a constantly uniformly emerging partial cooling gas flow and a segment disc 14′ arranged underneath the latter, for a partial cooling gas flow controllable in sectors. Both cooling rings 12, 12′ serve to cool a film tube 17 emerging from an annular nozzle 16 at the extrusion die 11.

A circumferentially arranged measuring device 31 is provided for controlling the thickness profile of the film tube 17, which measuring device 31 scans the film thickness at the film tube 17 above a freezing limit. A control device 34 is provided which varies in sectors the cooling gas flows as a function of the film thickness measured around the circumference.

The segment discs 14, 14′ are each arranged underneath the annular channels 13, 13′ in order to exert the greatest possible influence on reducing the film thickness tolerances in that the respective hotter material regions of the film tube at the entry into a cooling ring are controlled in sectors. The segment disc 14, 14′ are each connected to a blower 18, 18′ for the partial cooling gas flows controllable in sectors. A control device 19, 19′ is provided for dividing the cooling gas flows generated by the blower 18, 18′ into individual separate partial cooling gas flows which comprises a plurality of individually controllable flaps and/or valves. The cooling rings 12, 12′ can be axially adjusted relative to one another by adjusting means 15, with the lower cooling ring 12 preferably being secured directly to the extrusion die 11.

The control devices 19, 19′ which are controlled by the regulating device 34 permit a very accurate regulation of the thickness profile during the production of blown film due to the cooling gas supply which is controllable in sectors over a long axial range.

The controllable partial cooling gas flows are supplied in the direction of production of the film tube 17 in front of the uniform partial cooling gas flows and directed against the film tube 17 emerging from the extrusion die 11. The controllable partial cooling gas flows, before entering the segment discs 14, 14′, can be varied individually in their volume flow by the control devices 19, 19′.

The extrusion die 11 comprises an annular nozzle 16 which, with the vertical central axis A, emerges from the top end of the extrusion die. From the annular nozzle 16 there emerges the film tube 17 which is expanded and stabilised by an internal pressure generating device 20 and is pulled off upwardly by an extraction device 30. It is supported by a calibration basket 22 positioned above the cooling rings 12, 12′ and substantially defined in respect of its end diameter. The film tube 17 is enclosed annularly by the two cooling rings 12, 12′ with the annular channels 13, 13′ from which there escapes a substantially annularly uniform partial cooling gas flow, and by segment discs 14, 14′ which are positioned directly underneath and from which there escape partial cooling gas flows which are controllable in sectors. On the one hand, the cooling gas flows have a stabilising effect on the expanding film tube 17 and, on the other hand, they cool the plastic film material emerging from the annular nozzle 16 until, in a continuous freezing zone, the plastic expansion of the tube material is ended due to the cooling effect. The cooling rings 12, 12′ each substantially consist of a torus-shaped annular channel 13, 13′ which comprises some circumferentially distributed supply muffs 23, 23′ and at least one annular nozzle 24, 24′ from which the annularly uniform partial gas flow emerges as uniformly as possible.

The segment discs 14, 14′ each consist of an annular segment member produced in one piece which comprises a plurality of supply muffs 25, 25′ and which, at its inside close to the film tube 17, comprises individual exit nozzles 26, 26′ from which there emerge individual partial cooling gas flows which are controllable in sectors. Whereas the supply lines to the muffs 23, 23′ of the annular channels 13, 13′ are not illustrated, there are shown, by way of example, individual lines 27, 27′ leading to the supply muffs 25, 25′ of the segment discs 14, 14′. The lines are each connected to one of the control devices 19, 19′ which comprise a number of control valves 29, 29′ which corresponds to the actual number of circumferentially distributed lines 27, 27′ and of which four are shown by way of example and which are all air-pressure-loaded by a blower 18, 18′ via a supply line 28, 28′.

Above the calibration basket 22, a contact-free thickness measuring unit 31 is provided and which is arranged on a turntable 32 arranged coaxially relative to the tube and which, by periodically moving around the film tube 17, is able to measure the thickness distribution around the circumference. Between the individual measurements of the circumferential distribution of thickness, the measuring device 31 can be fixed in position and measure the longitudinal thickness values of the film tube along a longitudinal line, with the longitudinal thickness values being representative of the change in longitudinal thickness of the entire film tube. As is symbolised by a signal line 33, the results of the thickness measurements are processed in a control unit 34 of which one control line 35, 35′ leads to the blowers 18, 18′ and one control line 36, 36′ to the control devices 19, 19′. The control lines 35, 35′ allow the blower performance as a whole to be varied. It is possible to individually control the opening cross-section of the normally pulse-width-modulated control valves 29, 29′ via the control lines 36, 36′ which are representative of a plurality of control lines leading to the individual control valves 29, 29′.

The measurements of the circumferential thickness distribution can be converted into a control of the partial cooling air flows individually controllable in sectors, as a result of which the thickness profile is controlled to achieve the least possible deviations. The measurement of the longitudinal thicknesses serves to determine the period of change in longitudinal thickness which, by changing the cooling gas flows as a whole, can also be controlled to achieve as few deviations as possible.

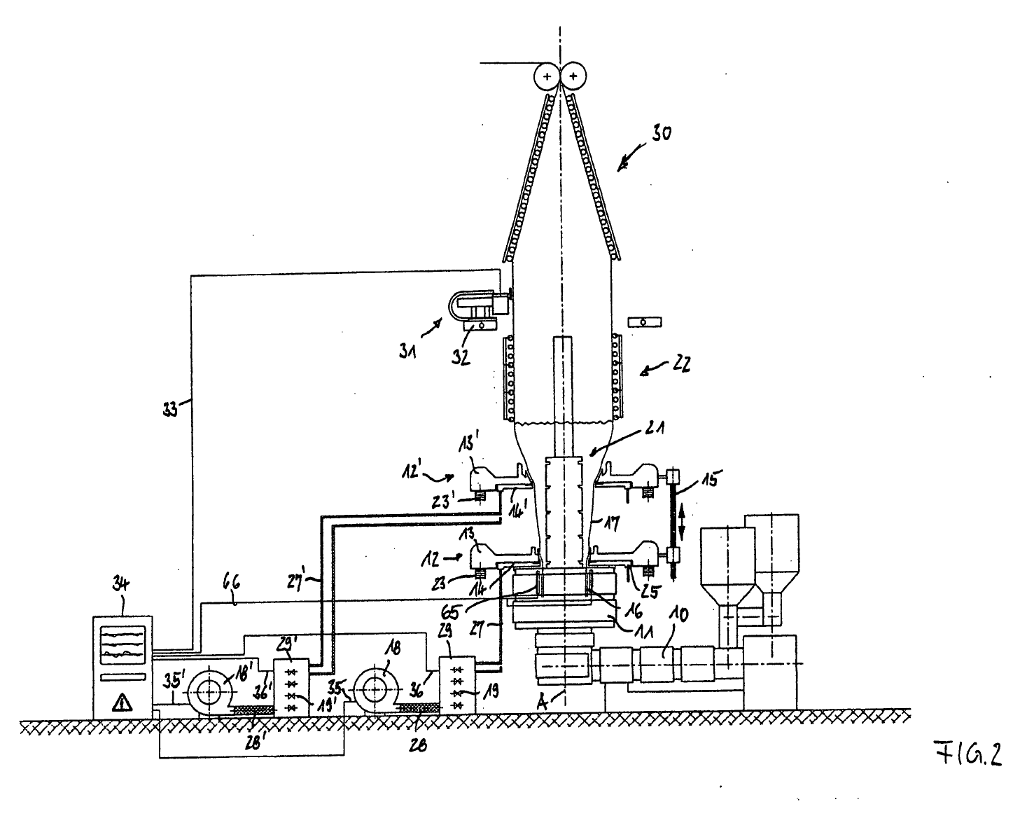

FIG. 2, in addition to the details of FIG. 1, shows in the extrusion head 11 a plurality of circumferentially distributed heating cartridges 65 or cooling elements (e.g. Peltier elements) which, via control lines 66, can be independently controlled by the regulating unit 34 in sectors. This permits an additional variable temperature setting for the film tube 17 prior to it leaving the annular nozzle 16.

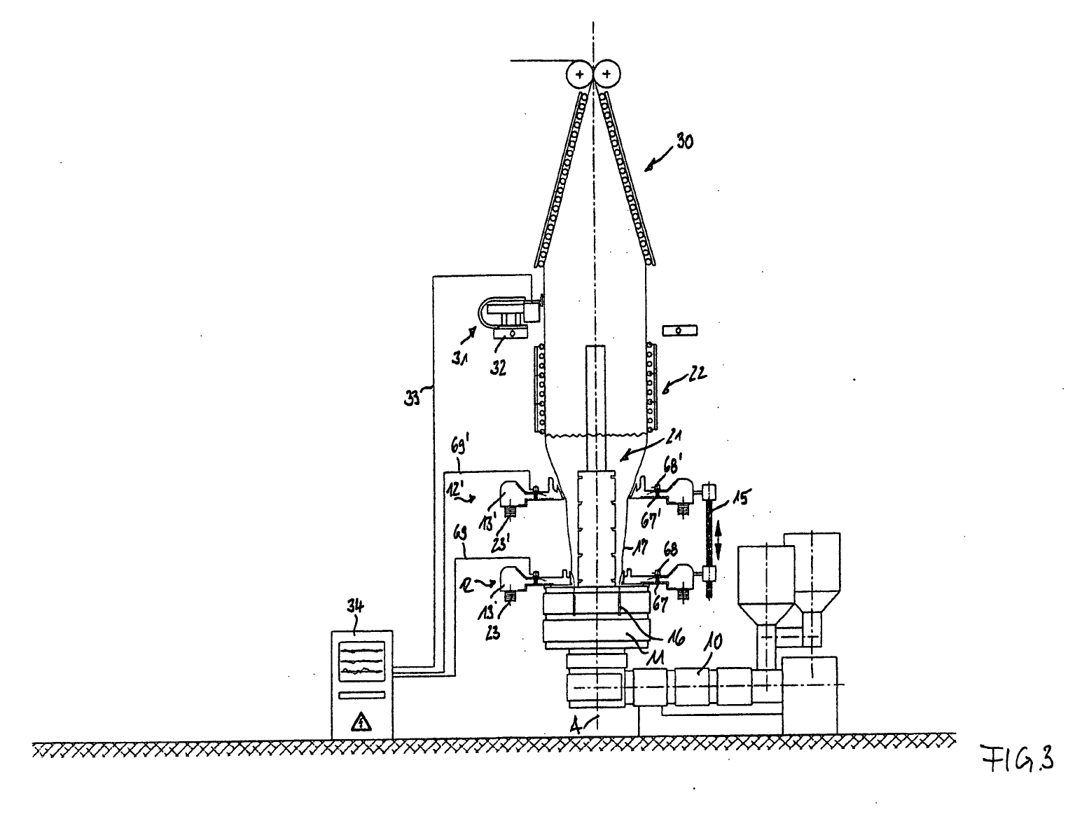

In FIG. 3, the cooling rings 12, 12′ can be provided in an alternative embodiment to deviate from FIG. 1 in that they do not comprise any segment discs, but only uniform annular channels 13, 13′ in which there are arranged circumferentially distributed control elements 67, 67′ (e.g. flaps) with setting members 68, 68′ which, in individual circumferential regions, are able to vary the volume flow individually. The setting units 68, 68′ are also connected to the central regulating unit 34 via control lines 69, 69′.

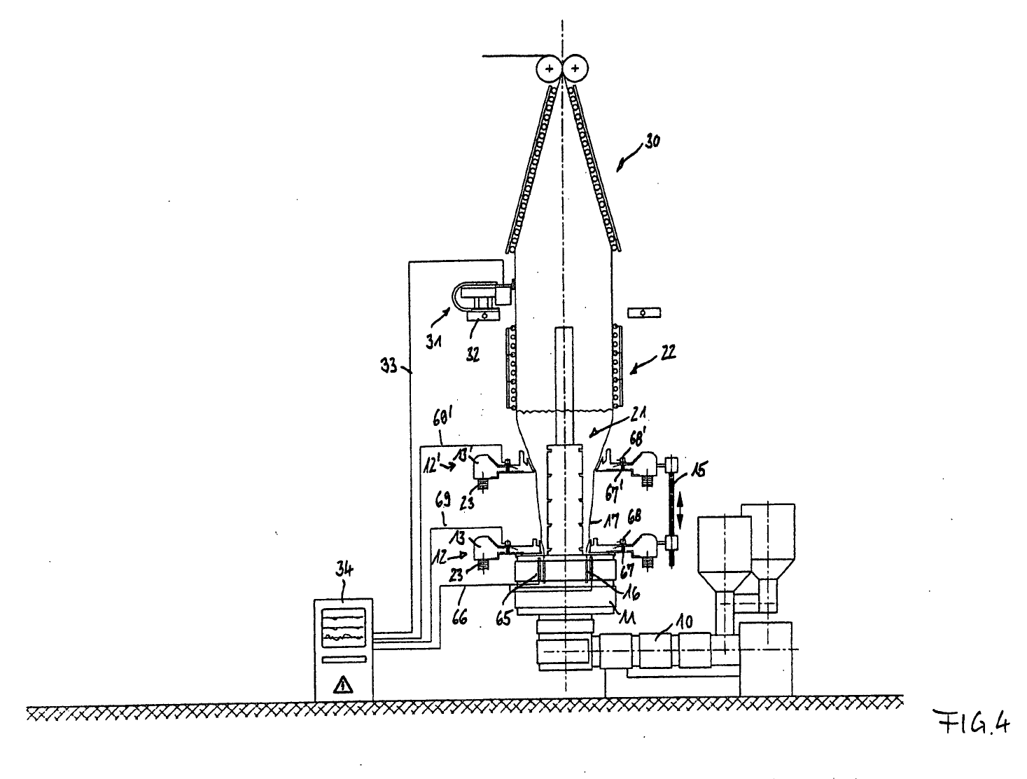

FIG. 4, in addition to the details of FIG. 1, shows in the extrusion head 11 a plurality of circumferentially distributed heating cartridges 65 or cooling elements (e.g. Peltier elements) which, via control lines 66, can be independently controlled by the regulating unit 34 in sectors. This permits an additional variable temperature setting for the film tube 17 prior to it leaving the annular nozzle 16.

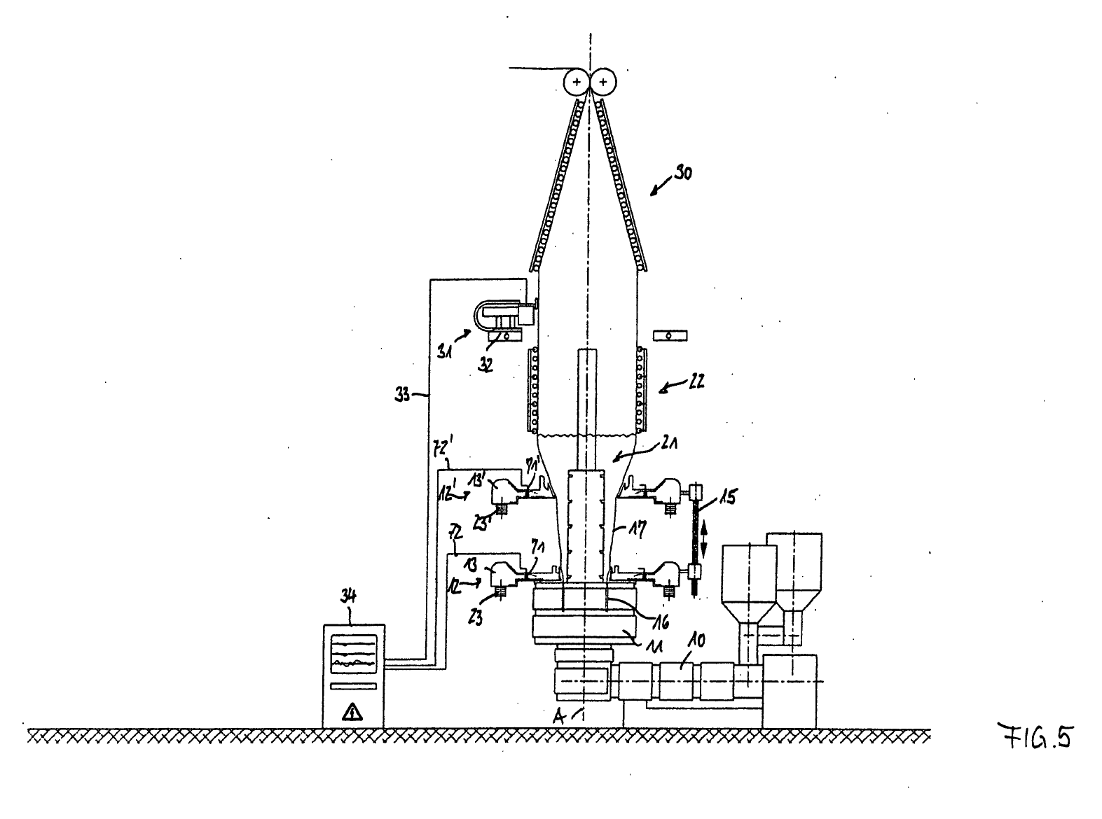

In FIG. 5, the cooling rings 12, 12′ can be provided in an alternative embodiment to deviate from FIG. 1 in that they do not comprise any segment discs, but only uniform annular channels 13, 13′ in which there are arranged circumferentially distributed heating cartridges 71, 71′ or cooling elements (e.g. Peltier elements) which, in individual circumferential regions, are able to independently set the temperature for the volume flow. The heating cartridges 71, 71′ are also connected to the central regulating unit 34 via control lines 72, 72′.

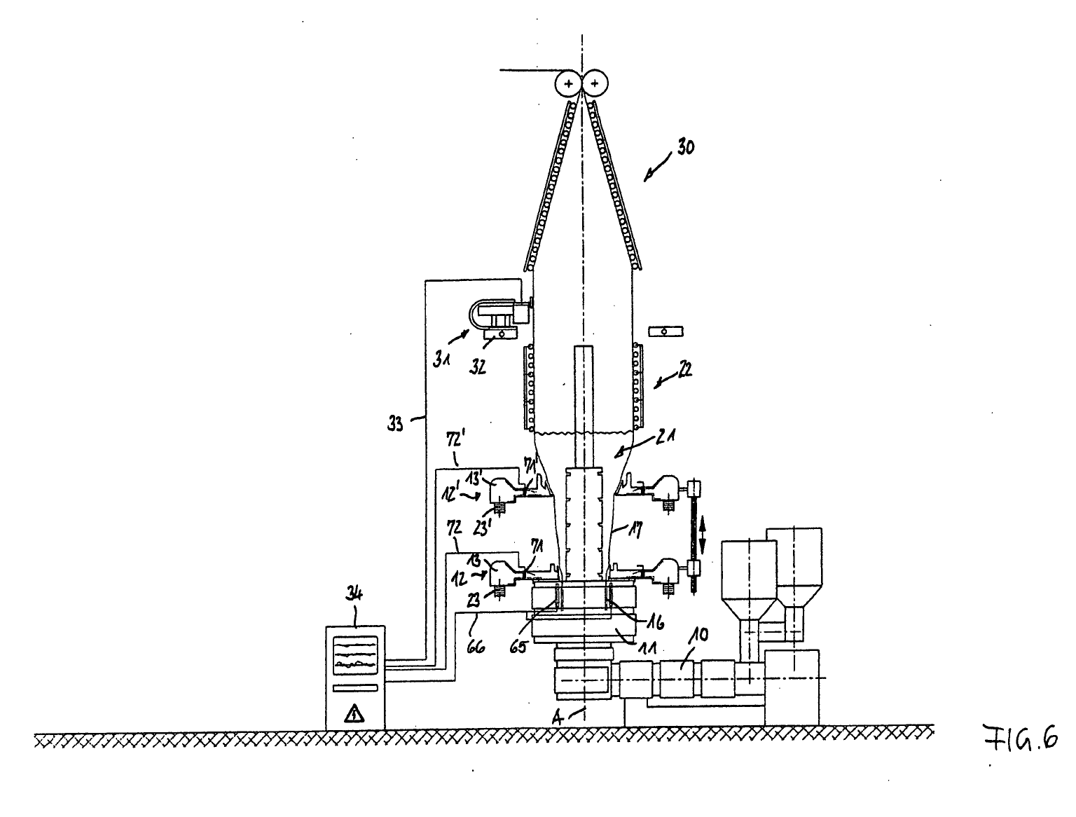

FIG. 6, in addition to the details of FIG. 5, shows in the extrusion head 11 a plurality of circumferentially distributed heating cartridges 65 or cooling elements (e.g. Peltier elements) which, via control lines 66, can also be independently controlled by the regulating unit 34 in sectors. This permits an additional variable temperature setting for the film tube 17 prior to it leaving the annular nozzle 16.

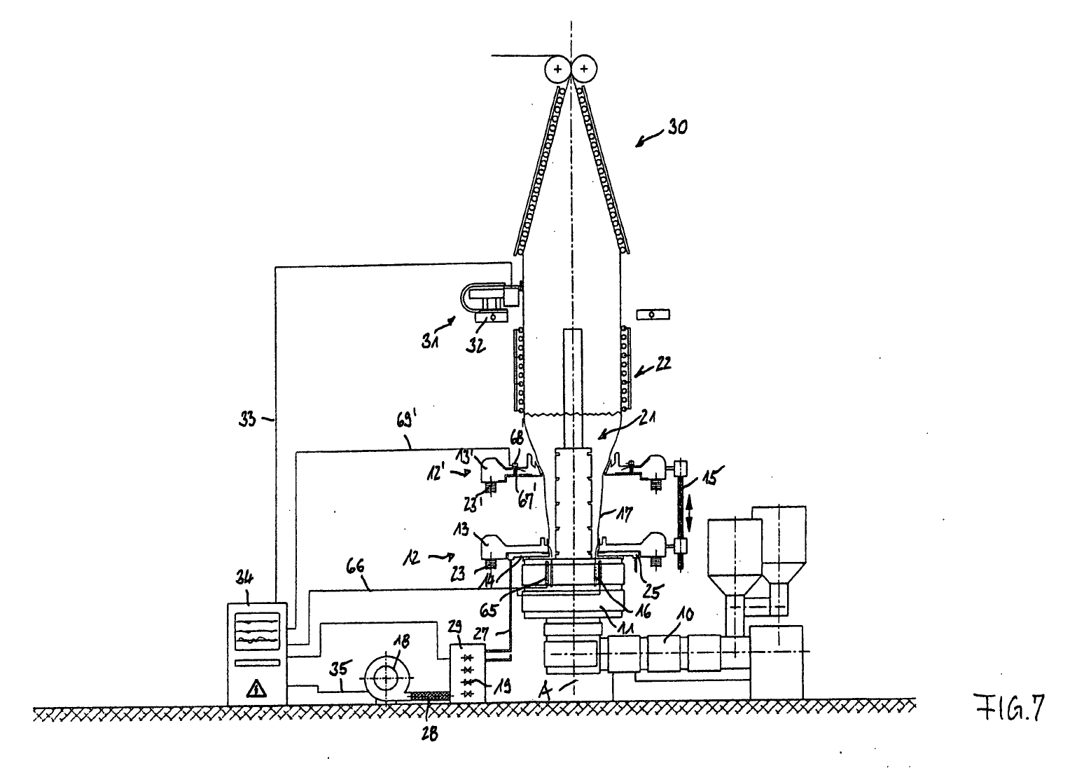

In FIG. 7, the lower cooling ring 12 and the control of same can be provided in an alternative embodiment as shown in FIG. 1, whereas the upper cooling ring 12′ and its control are designed like the cooling ring 12 shown in FIG. 3.

The inside of the extrusion die 11 can be provided with circumferentially distributed heating cartridges 65 or cooling elements (e.g. Peltier elements) which, via additional control lines 66, are circumferentially controllable in sectors.

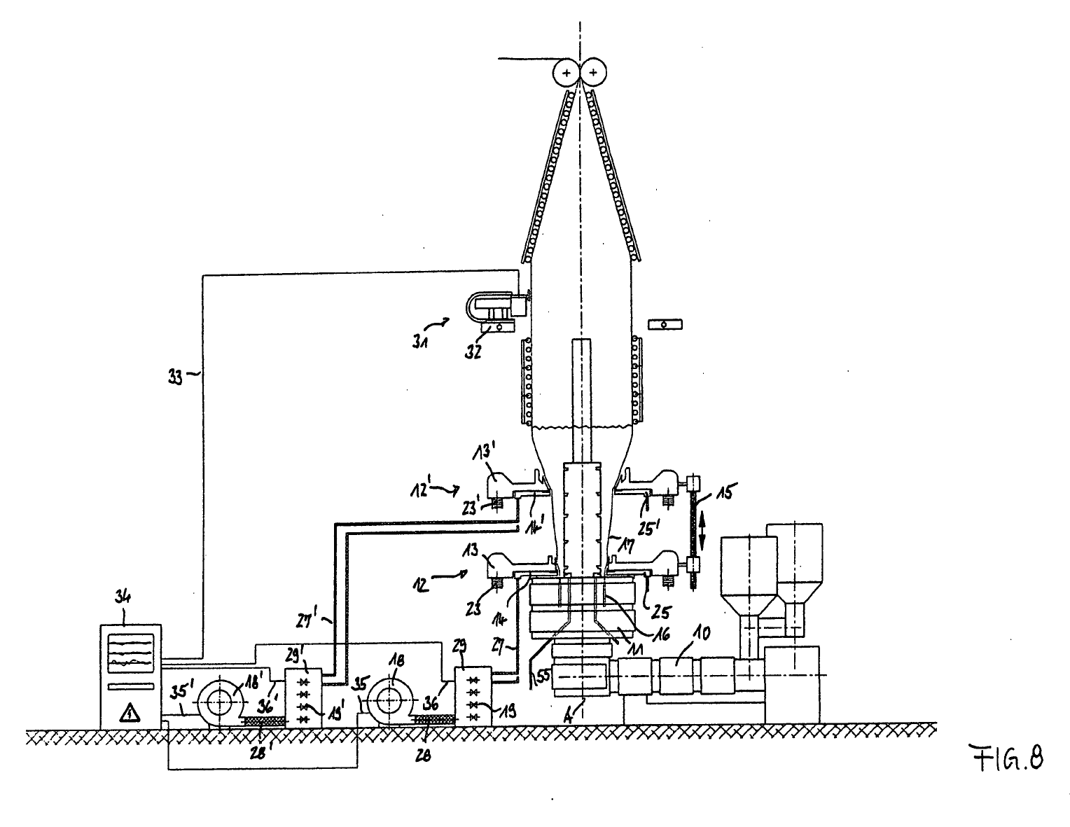

FIG. 8 shows an alternative embodiment of the invention shown in FIG. 1. Inside the film tube 17 there is additionally provided an inner cooling device 47 which is threaded on to the extrusion head 11 and comprises a plurality of elements which will be described in greater detail below. At the circumference of the device 47 there are provided annular nozzles 49, 50 which are arranged in different planes and which exit radially outwardly. The nozzles are supplied with cooling gas via an inner hollow chamber 51, which gas is subsequently extracted via a coaxial central extractor pipe 52 with an open upper end. Between the inner cooling device 47 and the extrusion head 11 there is inserted a further supplementary cooling ring 48 which generates a plurality of inner supplementary cooling gas flows 53 via individual nozzles 54 which, via individual supply lines 55, are supplied with cooling gas which is controllable in sectors. The lines 55 can be branch lines of the individual lines 27, so that certain circumferential regions of the film tube 17 can be charged with uniformly controlled additional cooling gas from the inside and outside in a way which is controllable in sectors.

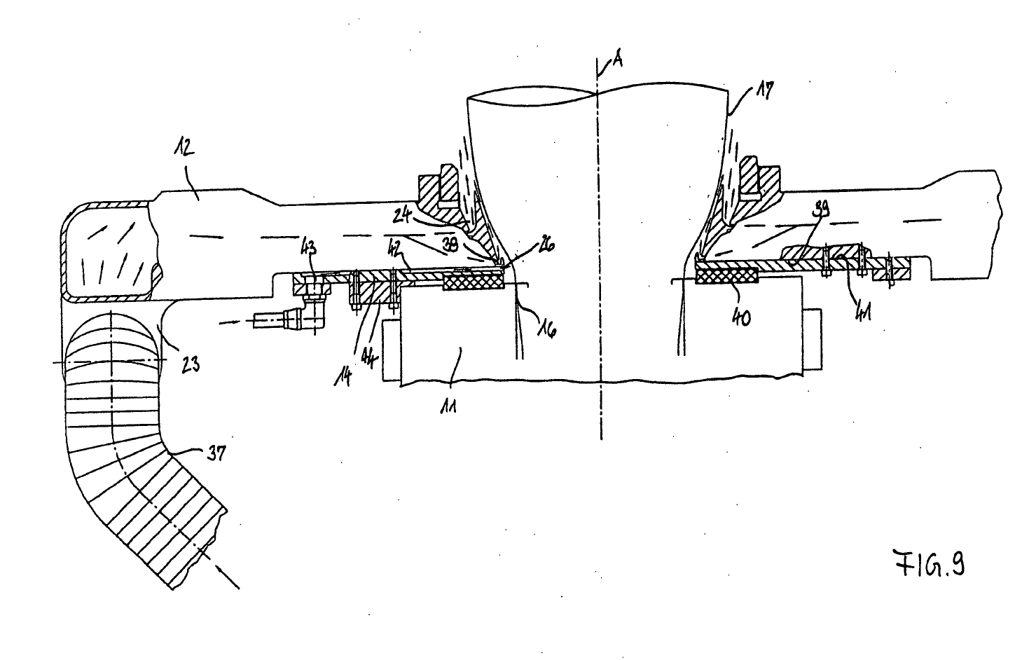

In FIG. 9, the annular nozzle 16 and the lower cooling ring 12 are shown in an enlarged partial section. One of the supply muffs 23 is followed by a supply line 37. It can be seen that the lower cooling ring 12 is provided in the form of an annular channel 13 which, in addition to a first nozzle exit ring 24, comprises a further nozzle exit ring 38. The annular channel 13 comprises a lower planar face 39 at least in its inner region against which there is threaded a segment disc 14 which comprises an upper substantially planar face 41.

A segment disc 14 can provided with individual radial grooves 42 which, on their radial outside portions, can be connected via through-holes 43 to the individual connecting pieces 25 whereas, on their radial inside portions, they can end in the supplementary nozzles 26. The radial grooves 42, together with the planar face 39, form the individual cooling gas channels. The segment disc 14 can be centred relative to the extrusion head 11 by centring clamps 44. The annular channel 13 threaded to the segment disc 14 can also be centred by said centring clamps 44 relative to the extrusion die 11. An insulating disc 40 can be positioned between the extrusion die 11 and the segment disc 14 in the region of the individual nozzles 26. The design of the upper cooling ring (not shown) can be identical with the exception of its diameter.

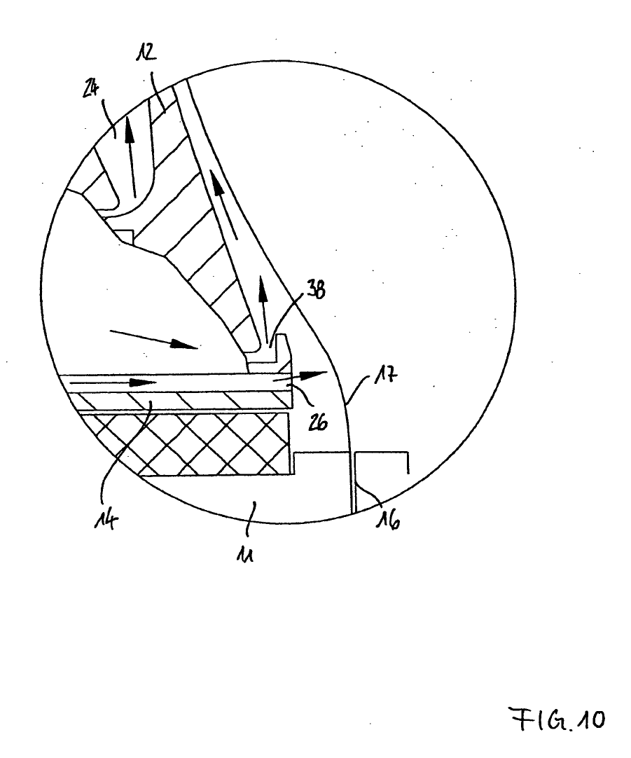

FIG. 10 shows the extrusion die 11 in the form of a detail in an enlarged drawing as in FIG. 9, having an annular nozzle 16 from which there emerges the film tube 17 which, for the sake of simplicity, is shown with a uniform wall thickness. On the extrusion die 11, the insulating disc 40 can be provided, above which the annular channel 13 can be positioned with the annular nozzles 24, 38 and the segment disc 14 can be threaded on underneath and have individual nozzles 26.

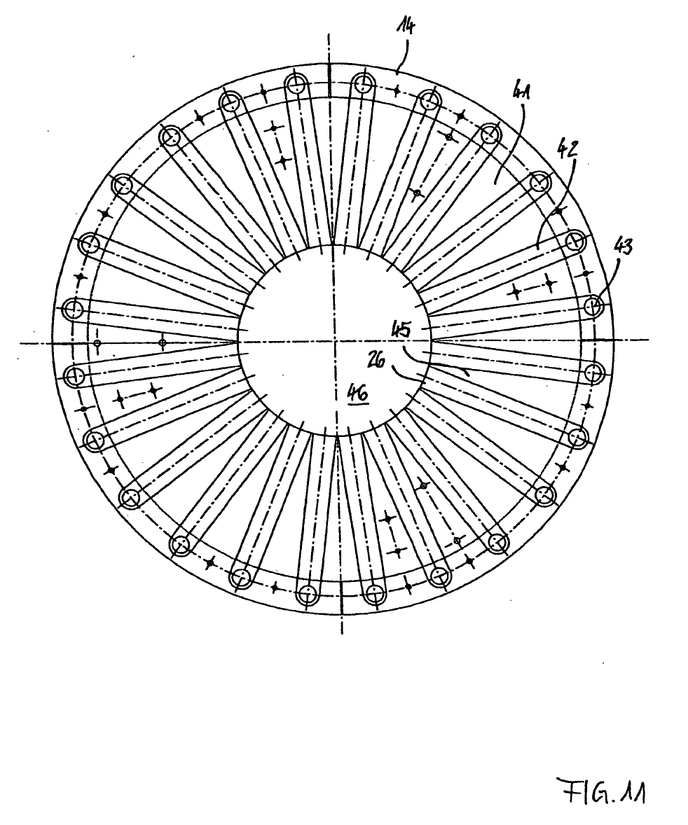

FIG. 11 shows the segment disc 14 according to FIG. 9 in the form of a detail in a plan view. In a substantially planar flange face 41, the radial grooves 42 are provided and which end on the outside at a distance from the circumferential disc. The radial grooves 42 can be connected to the through-holes 43 and which end towards the inside in nozzle apertures 26 separated from one another by intermediate webs 45. In the centre, a central through-hole 46 can be provided for the film tube.

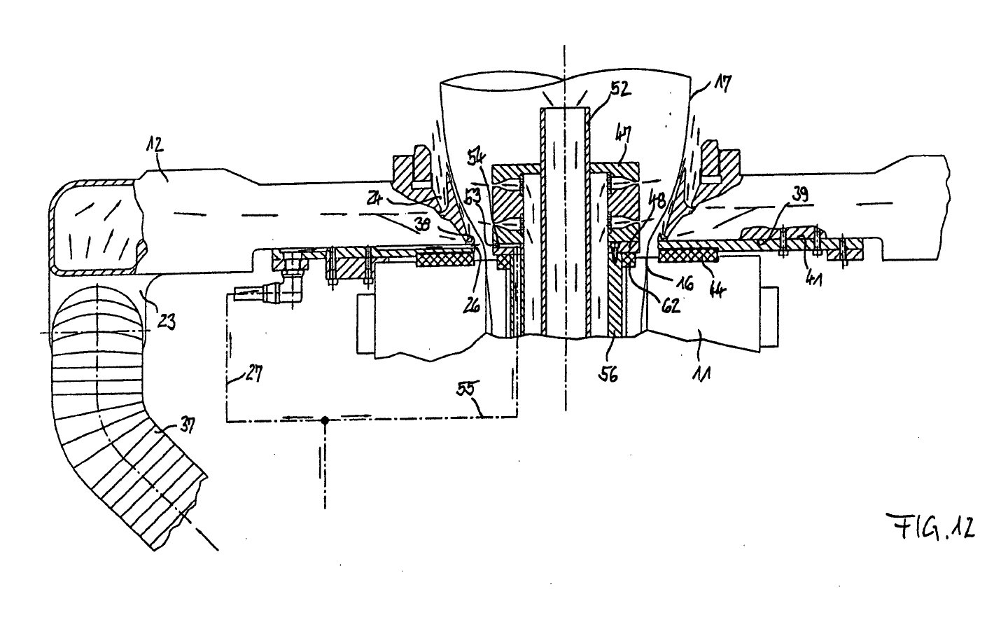

In FIG. 12 the extrusion die 11, the lower cooling ring 12 with the annular channel 13 and the segment disc 14 are illustrated in an alternative embodiment, and such as shown in FIG. 9. Identical details have been given the same reference numbers and to that extent, reference is therefore made to the description of same. Inside the film tube 17, the inner cooling device 47 is provided which has been placed on to the extrusion die 11 whose lowermost element is the inner supplementary cooling ring 48 which is threaded onto the cylindrical pipe 56 inside the extrusion die 11.

Inside the pipe 56, supply lines 55 are provided in the form of bores. The supplementary cooling ring 54 comprises through-bores 57 for providing a connection with the supply lines 55 as well as with radial grooves 59 which are provided in a planar face 58 and whose ends form the individual nozzles 54. Furthermore, the inner cooling device 47 can comprise a plurality of disc elements which are placed one above the other and of which the lower one comprises a planar underside 60 which upwardly closes off the radial grooves 59, so that there are formed individual cooling gas channels. The individual disc elements, together, form annular nozzles 49, 50 and are connected to one another by grid sleeves. A further insulating ring 62 is provided between the segment disc and the extrusion die 11.

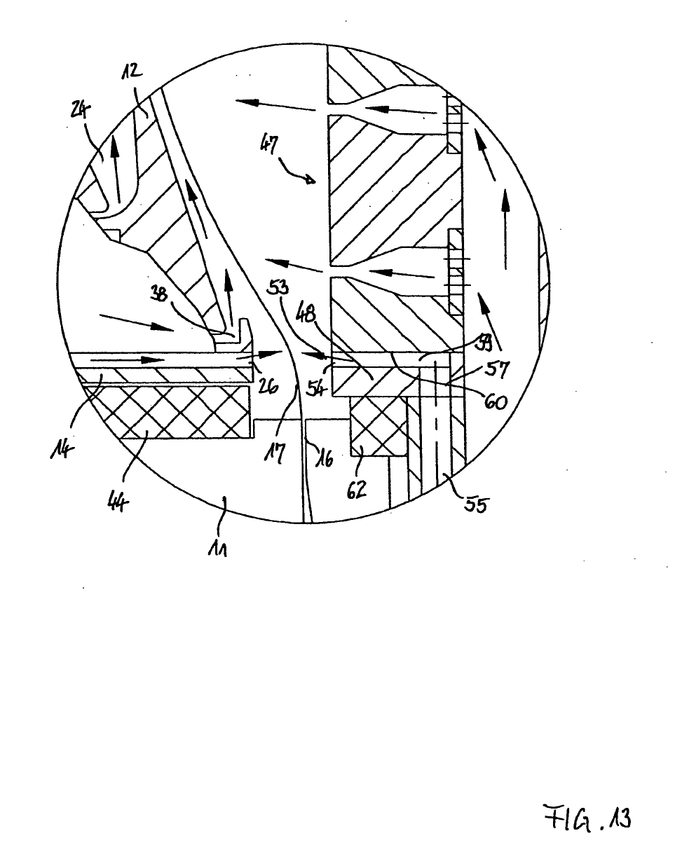

In FIG. 13, an alternative embodiment of the invention is shown for the device as shown in FIG. 12. In such an embodiment, the formation of the supplementary cooling gas exits 54 through the supplementary cooling ring 48 and the lower one of the annular elements of the inner cooling device 47 as well as the connection of the through-bores 57 with the supply channels 55 being particularly clearly visible.

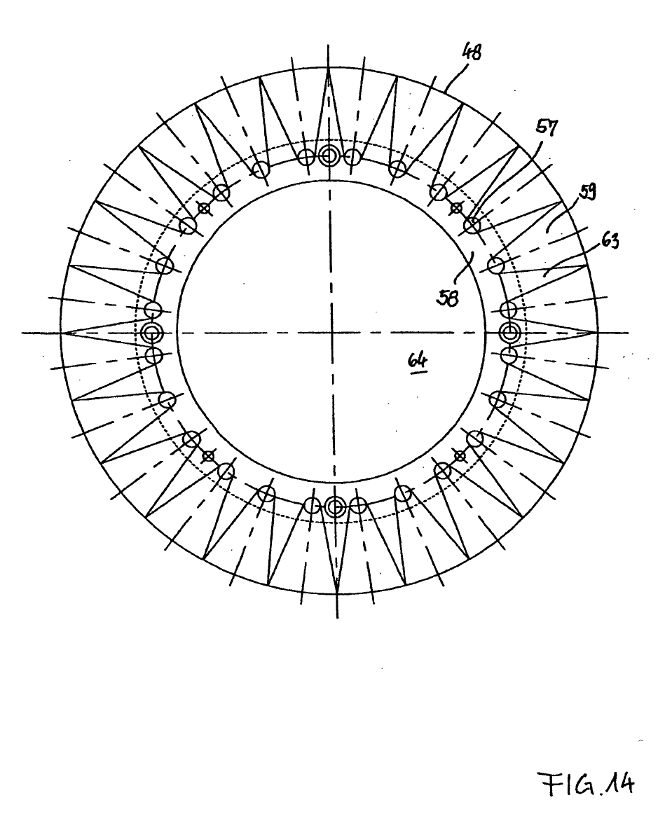

FIG. 14 shows the inner supplementary cooling ring 48 with the above-mentioned details, i.e. the through-bores 57 and the radial grooves 59 milled into a planar surface 58. Close up to the outer circumference, said radial grooves 59 are separated from one another by separating webs 63. The annular disc 48 comprises a central aperture 64 for the general supply of cooling gas.

Thus, a process of controlling the thickness profile of a blown tubular film is described. The process produces blown film by means of blown film extruders, having a film extrusion die, wherein the blown tubular film can comprise thermoplastic plastic. The process includes measuring the film thickness of the tubular film around the circumference by a measuring device, variably controlling the cooling gas flow as a function of the measured film thickness around the circumference in sectors by a control device, and supplying cooling gas flows from the outside in the direction of production in two planes arranged at a distance from one another, and variably controlling the cooling gas flows in sectors around the circumference in the two planes in respect of their physical parameters.

We claim:

1. A process of controlling the thickness profile of a blown tubular film, comprising measuring the film thickness of the tubular film around a circumference, variably controlling cooling gas flow as a function of a measured film thickness around the circumference in sectors, supplying cooling gas flows from an outside and in a direction of production in two planes arranged at a distance from one another, wherein the cooling gas flows are variably controlled in sectors around the circumference in the two planes in respect of their physical parameters.

2. The process according to claim 1, wherein the cooling gas flows are controlled in sectors in their volume flow.

3. The process according to claim 1, wherein the cooling gas flows are controllable in sectors in respect of their temperature.

4. The process according to claim 1, wherein at least one of the two controllable cooling gas flows further comprises at least one partial flow held so as to be constant around the circumference and of a partial flow controllable in sectors around the circumference.

5. The process according to claim 1, wherein the temperature setting at the region of the film extrusion die for the tubular film is controlled in sectors around the circumference.

6. The process according to claim 1, wherein at least one further cooling gas flow is controlled in sectors around the circumference and is fed into the tubular film from the inside.

7. The process according to claim 1, wherein the lower one of the two cooling gas flows supplied from the outside is supplied on a smaller diameter than the upper one of the two cooling gas flows supplied from the outside.

8. The process according to claim 4, wherein the circumferentially constant partial flow of the at least one cooling gas flow is supplied into at least two blowing-out planes.

9. A device for controlling the thickness profile of a blown tubular film, comprising a measuring device for measuring the thickness profile of the tubular film, which measuring device measures the film thickness of the tubular film above a freezing limit around a circumference; a control device which controls the cooling gas flows variably around the circumference, which control is provided as a function of the measured film thickness; and two cooling rings arranged above a film extrusion die of a blown film extruder in two planes arranged at a distance from one another, wherein that the two cooling rings comprise means for variably controlling the cooling gas flows in sectors around the circumference.

10. The device according to claim 9, further comprising means for changing volume flow of the cooling gas in sectors around the circumference which are independently controllable.

11. The device according to claim 9, further comprising means for variably setting the temperature of the cooling gas flow in sectors around the circumference which are independently controllable.

12. The device according to claim 9, wherein at least one of the cooling rings further comprises a circumferentially uniform annular nozzle and an annular nozzle which is variably controllable circumferentially in sectors.

13. The device according to claim 9, wherein the film extrusion die further comprises circumferentially distributed, individually controllable heating cartridges.

14. The device according to claim 9, further comprising at least one inner blowing nozzle arranged inside the tubular film, which nozzle is independently controllable in sectors around the circumference and which comprises means for variably controlling a cooling gas flow in sectors around the circumference.

15. The device according to claim 9, wherein the lower one of the two cooling gas rings further comprises an inner diameter of the two cooling gas rings smaller than an upper diameter of the two cooling gas rings.

16. The device according to claim 12, wherein the circumferentially uniform annular nozzle further comprises at least two blowing-out planes arranged one above the other.

17. The device according to claim 9, further comprising a lower entry diameter for the tubular film at the cooling rings, which lower entry diameter is smaller than an upper exit diameter for the tubular film.

18. The device according to claim 17, further comprising an inner cone, which inner cone has an entry diameter and the exit diameter, wherein the distance between the entry diameter and the exit diameter comprises a smaller opening angle at the lower cooling ring than at the upper cooling ring.

19. The device according to claim 9, wherein the film extrusion die comprises circumferentially distributed, individually controllable cooling members.
